(19) United States
(12) Patent Application Publication
(10) Pub. No.: US 2026/0296546 A1
(43) Pub. Date: Oct. 1, 2026

(54) SUSPENSION MEMBER STRUCTURE

(71) Applicant: TOYOTA JIDOSHA KABUSHIKI KAISHA, Toyota-shi (JP)

(72) Inventor: Takahiro ITO, Toyota-shi (JP)

(73) Assignee: TOYOTA JIDOSHA KABUSHIKI KAISHA, Toyota-shi (JP)

(21) Appl. No.: 19/367,650

(22) Filed: Oct. 23, 2025

(30) Foreign Application Priority Data
Dec. 3, 2024 (JP) 2024-210682

(51) Int. Cl. B62D 21/11

(52) U.S. Cl. CPC B62D 21/11

(57) ABSTRACT

A suspension member structure includes a suspension member and a rigid member that is provided in a plate shape and is attached to the suspension member to reinforce the suspension member. The rigid member is provided with a rib that suppresses deformation of the rigid member in a thickness direction of the rigid member, and an opening (first opening, second opening) that penetrates the rigid member is provided in a portion of the rigid member different from the portion in which the rib is provided.

### CROSS-REFERENCE TO RELATED APPLICATION

This application claims priority to Japanese Patent Application No. 2024-210682 filed on Dec. 3, 2024. The disclosure of the above-identified application, including the specification, drawings, and claims, is incorporated by reference herein in its entirety.

### BACKGROUND

### 1. Technical Field

The present disclosure relates to a suspension member structure.

### 2. Description of Related Art

Japanese Unexamined Patent Application Publication No. 2012-041009 (JP 2012-041009 A) discloses a rear structure of a vehicle including motors that independently drive right and left rear wheels. A rear portion of the vehicle described in the document includes a pair of right and left rear side frames extending in a vehicle front-rear direction, a pair of right and left motors that independently drives right and left rear wheels, a motor mounting member, and a cross member. Here, the cross member extends in the vehicle width direction behind the right and left motors. Here, the motor mounting member is a motor mounting member for mounting the right and left motors on the vehicle body. A rear portion of the motor mounting member is connected to the cross member and a front portion of the motor mounting member is connected to the right and left rear side frames. As a result, the right and left motors are attached to the vehicle body via the motor mounting member.

### SUMMARY

In a vehicle provided with a suspension member to which an arm or the like that supports a wheel is attached, one approach to increase rigidity of the suspension member is to attach a plate-shaped rigid member to the suspension member. In this case, suppressing vibration of the rigid member while securing rigidity of the rigid member is desirable.

The present disclosure is made in view of the fact described above, and an object of the present disclosure is to obtain a suspension member structure capable of suppressing the vibration of the rigid member while securing the rigidity of the rigid member.

A suspension member structure according to a first aspect includes
a suspension member, and
a rigid member that is plate-shaped and that is attached to the suspension member to reinforce the suspension member.

A rib that suppresses deformation in a thickness direction of the rigid member is provided in the rigid member, and
an opening is provided in the rigid member in a portion that is different from a portion in which the rib is provided. The rigid member penetrates the rigid member.

In the suspension member structure according to the first aspect, the rigid member is attached to the suspension member, so that the rigidity of the suspension member is increased. Here, the rib that suppresses deformation in the thickness direction of the rigid member is provided in the rigid member. As a result, the rigidity of the rigid member can be secured. In addition, the opening is provided in the rigid member in the portion that is different from the portion in which the rib is provided, and the opening penetrates the rigid member. With this configuration, air around the rigid member can pass through the opening from one side to the other side in the thickness direction of the rigid member. As a result, it is possible to suppress the vibration of the rigid member due to wind pressure.

In the suspension member structure according to a second aspect, in the suspension member structure in the first aspect,
the rib is provided along an edge of the opening.

In the suspension member structure according to the second aspect, the rib is provided along the edge of the opening, whereby it is possible to suppress the decrease in rigidity of the rigid member due to providing the opening.

In the suspension member structure according to a third aspect, in the suspension member structure according to the first or the second aspect,
the rigid member is rectangular-shaped when viewed in the thickness direction, and the rib is provided along a diagonal line of the rigid member.

In the suspension member structure according to the third aspect, the rib is provided along the diagonal line of the rigid member that is rectangular-shaped. With this configuration, it is possible to easily secure the rigidity of the rigid member as compared with a configuration in which the rib is not provided along the diagonal line of the rigid member that is rectangular-shaped.

In the suspension member structure according to a fourth aspect, in the suspension member structure according to any one of the first to the third aspect, the opening is a clearance portion for avoiding interference with a member supported by the suspension member.

In the suspension member structure according to the fourth aspect, the opening is provided in the rigid member, so that interference between the member supported by the suspension member and the rigid member can be avoided.

The suspension member structure according to the present disclosure has an excellent effect of being able to suppress the vibration of the rigid member while securing the rigidity of the rigid member.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view showing a suspension member or the like;

FIG. 2 is a side view showing a suspension member or the like; and

FIG. 3 is a plan view showing the rigid member.

### DETAILED DESCRIPTION OF EMBODIMENTS

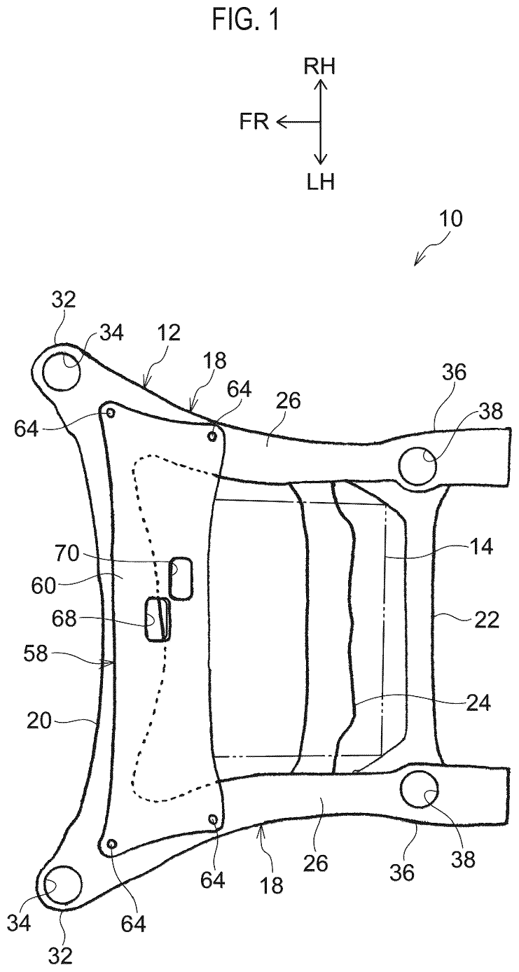

The rear portion 10 of the vehicle to which the suspension member structure according to the embodiment of the present disclosure is applied will be described with reference to FIGS. 1 to 3. In addition, an arrow FR shown in each drawing as appropriate indicates a front side of the vehicle, an arrow UP indicates an upper side of the vehicle, an arrow LH indicates a left side in a vehicle width direction (right-left direction), and an arrow RH indicates a right side in the vehicle width direction (right-left direction). In addition, in the following description, when the front and rear, the up and down, and the right-left directions are indicated without special mention, the front-rear direction of the vehicle, the up and down direction of the vehicle, and the right-left direction of the vehicle are indicated.

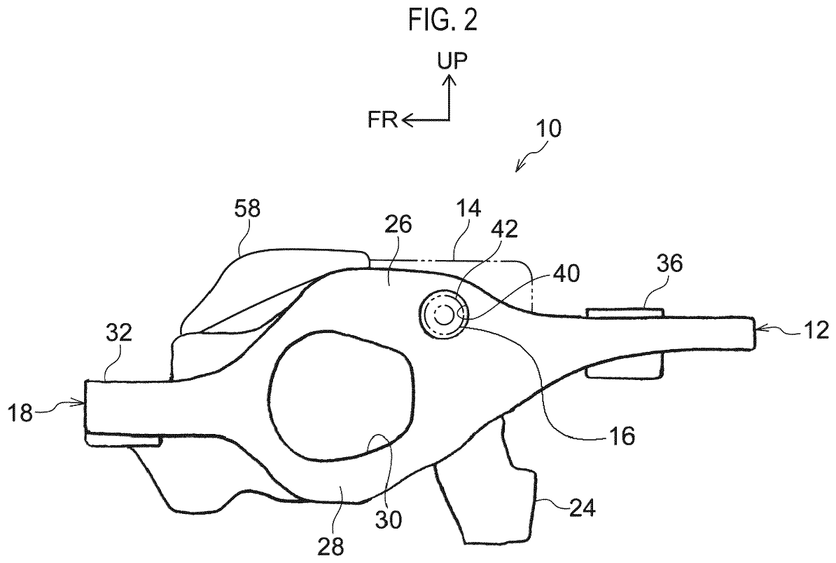

As shown in FIGS. 1 and 2, a suspension member 12 is provided in a rear portion 10 of a vehicle to which the suspension member structure of the present embodiment is applied. Various arms (not shown) that support right and left rear wheels are attached to the suspension member 12. In FIGS. 1 and 2, a portion in which various arms or the like are attached to the suspension member 12 is omitted. The suspension member 12 supports a motor 14 for driving right and left rear wheels via a motor mount 16. In addition, a rigid member 58 is attached to the suspension member 12.

The suspension member 12 is provided by, for example, aluminum die-casting, and has a configuration in which each part described below is integrally provided. The suspension member 12 includes a pair of right and left side member portions 18 on both sides in the vehicle width direction, each extending in the front-rear direction, and a front cross member portion 20 connecting front end portions of the right and left side member portions 18 in the right-left direction. The suspension member 12 includes a rear cross member portion 22 that connects rear ends of the right and left side member portions 18 to each other in the right-left directions, and an intermediate cross member portion 24 that connects intermediate portions in the front-rear direction of the right and left side member portions 18 to each other in the right-left directions.

As shown in FIG. 1, the shape of the range from the center portion of the right and left side member portions 18 in the front-rear direction to the front end portion of the side member portions 18 as viewed from the upper side is a shape that is gradually curved to the outside in the vehicle width direction toward the front side. As shown in FIG. 2, the intermediate portion of the right and left side member portions 18 in the front-rear direction includes an upper intermediate member portion 26 extending in the front-rear direction and a lower intermediate member portion 28 extending in the front-rear direction at a lower side of the upper intermediate member portion 26. An opening 30 through which a drive shaft for transmitting the rotation of the motor 14 to the rear wheels can pass in the right-left direction is provided between the upper intermediate member portion 26 and the lower intermediate member portion 28.

As shown in FIGS. 1 and 2, a front-side fixing portion 32 fixed to a vehicle body (not shown) is provided at a front end portion of each of the right and left side member portions 18. A mounting member mounting hole 34 to which a mounting member (not shown) is mounted by press-fitting or the like is provided in the front-side fixing portion 32. Then, the mounting member mounted in the mounting member mounting hole 34 is fixed to the vehicle body, so that the front-side fixing portion 32 is fixed to the vehicle body.

A rear-side fixing portion 36 fixed to a vehicle body (not shown) is provided on a rear end side of each of the right and left side member portions 18. In the rear-side fixing portion 36, a mounting member mounting hole 38 for mounting a mounting member (not shown) by press-fitting or the like is provided. Then, the mounting member mounted in the mounting member mounting hole 38 is fixed to the vehicle body, so that the rear-side fixing portion 36 is fixed to the vehicle body.

As shown in FIG. 1, the shape of the front cross member portion 20 as viewed from the upper side is a shape that is gradually curved toward the rear side toward the center portion in the vehicle width direction. The front cross member portion 20 is provided between the front-side fixing portions 32 of the right and left side member portions 18. The rear cross member portion 22 is provided between the rear-side fixing portions 36 of the right and left side member portions 18. Further, as shown in FIGS. 1 and 2, the intermediate cross member portion 24 is provided between the rear end portions of the lower intermediate member portion 28 of the right and left side member portions 18.

As shown in FIG. 2, motor mount mounting holes 40 as mounting holes penetrating in the vehicle width direction are provided in the rear end side of the upper intermediate member portion 26 of each of the right and left side member portions 18. The bush 42 constituting a part of the motor mount 16 is press-fitted from the outside in the vehicle width direction into the motor mount mounting hole 40. The motor mount body that constitutes another part of the motor mount 16 is fixed to the bush 42. The motor 14 disposed between the right and left side member portions 18 is supported by the suspension member 12 through the motor mount body and the bush 42.

As shown in FIGS. 1 to 3, the rigid member 58 is provided by, for example, aluminum die-casting, and has a configuration in which each part described below is integrally provided. The rigid member 58 includes a rigid member main body 60 provided in a plate shape extending in the right-left direction and the front-rear direction. The rigid member 58 includes a rib 62 that protrudes from the rigid member main body 60 toward a lower side.

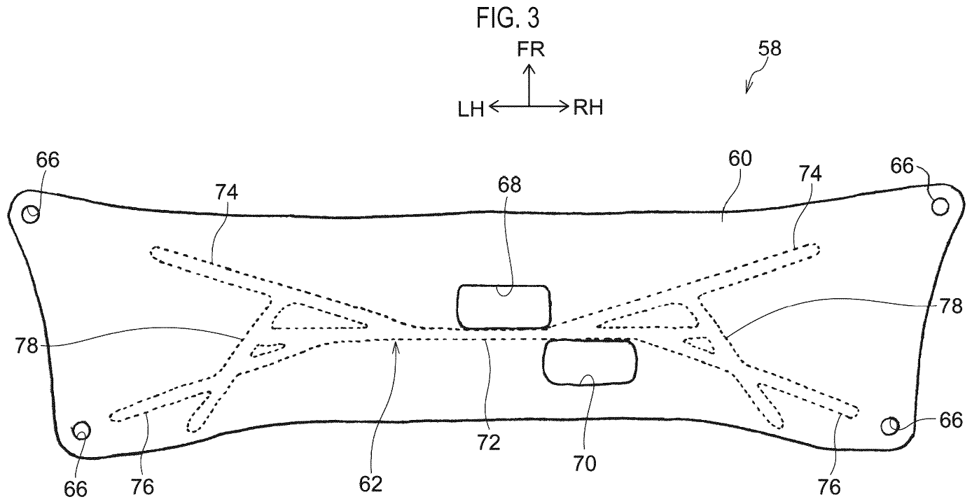

The shape of the rigid member main body 60 as viewed from the thickness direction is formed in a rectangular shape (rectangular shape) in which the right-left direction is the longitudinal direction. The rigid member main body 60 is configured to curve downward toward the front side. As shown in FIGS. 1 and 3, insertion holes 66 into which fastening members 64, such as bolts, are inserted are provided in a right-front end portion, a right-rear end portion, a left-front end portion, and a left-rear end portion of the rigid member main body 60. Then, the fastening members 64 inserted into the four insertion holes 66 are respectively screwed into the screw portions provided in the right and left side member portions 18, whereby the rigid member 58 is attached to the suspension member 12. In a state where the rigid member 58 is attached to the suspension member 12, the rigid member 58 is provided between the front side portions of the right and left side member portions 18.

The first opening 68 as an opening and the second opening 70 as an opening are provided in the rigid member main body 60 in a rectangular shape (rectangular shape) with the right-left direction as the longitudinal direction. The first opening 68 is provided to penetrate the rigid member main body 60 at the center portion of the rigid member main body 60 in the right-left direction and the front-rear direction. In addition, the second opening 70 is provided to penetrate the rigid member main body 60 on the right-rear side with respect to the first opening 68.

As shown in FIG. 3, the rib 62 is configured to protrude downward from the rigid member main body 60, and functions to secure the bending rigidity and the torsional rigidity of the rigid member main body 60. The rib 62 includes a first rib portion 72 that extends in the right-left direction at the center portion of the rigid member main body 60 in the front-rear direction. The first rib portion 72 is provided along the rear edge of the first opening 68 and the front edge of the second opening 70. The rib 62 includes a pair of right and left second rib portions 74 that respectively extend from a portion on the center portion side in the right-left direction in the first rib portion 72 toward the right-front side and the left-front side. Further, the rib 62 includes a pair of right and left third rib portions 76 that respectively extend from a part of the first rib portion 72 on the end portion side in the right-left direction to the right-rear side and the left-rear side. The rib 62 includes a pair of right and left fourth rib portions 78 that respectively extend from the intermediate portion in the longitudinal direction of the right and left second rib portions 74 toward the right-rear side and the left-rear side. The fourth rib portion 78 on the right side is connected to the end portion of the first rib portion 72 on the right side and the center portion of the third rib portion 76 in the longitudinal direction. In addition, an end portion in the fourth rib portion 78 on the right side, which is on the side opposite to the second rib portion 74 on the right side, is configured to protrude rearward with respect to the third rib portion 76 on the right side. The fourth rib portion 78 on the left side is connected to the end portion of the first rib portion 72 on the left side and the center portion of the third rib portion 76 in the longitudinal direction. In addition, an end portion in the fourth rib portion 78 on the left side, which is on the side opposite to the second rib portion 74 on the left side, is configured to protrude rearward with respect to the third rib portion 76 on the left side.

When the rigid member main body 60 is viewed from the thickness direction (here, the upper side), the range from the second rib portion 74 on the right side to the third rib portion 76 on the left side through the intermediate portion in the right-left direction of the first rib portion 72 is substantially along the diagonal line drawn from the right-front end portion to the left-rear end portion of the rigid member main body 60. Similarly to this, the range from the second rib portion 74 on the left side to the third rib portion 76 on the right side through the intermediate portion in the right-left direction of the first rib portion 72 is substantially along the diagonal line drawn from the left-front end portion to the right-rear end portion of the rigid member main body 60.

As shown in FIGS. 1 to 3, in the embodiment described above, the rigidity of the suspension member 12 is increased by mounting the rigid member 58 on the suspension member 12. Here, a rib 62 that suppresses deformation of the rigid member main body 60 in the thickness direction is provided in the rigid member main body 60. As a result, the rigidity of the rigid member 58 can be secured. Further, a first opening 68 and a second opening 70 that penetrate the rigid member main body 60 of the rigid member are provided in a portion different from the portion in which the rib 62 is provided in the rigid member main body 60 of the rigid member. With this configuration, the air around the rigid member can pass through the first opening 68 and the second opening 70 from one side in the thickness direction of the rigid member main body 60 to the other side. As a result, it is possible to suppress the vibration of the rigid member 58 (rigid member main body 60) due to the wind pressure.

In the present embodiment, the first rib portion 72 constituting a part of the rib 62 is provided along the rear edge of the first opening 68 and the front edge of the second opening 70. As a result, it is possible to suppress the decrease in rigidity of the rigid member 58 (rigid member main body 60) due to providing the first opening 68 and the second opening 70.

In the present embodiment, when the rigid member main body 60 is viewed from the upper side, the range from the second rib portion 74 on the right side to the third rib portion 76 on the left side through the intermediate portion in the right-left direction of the first rib portion 72 is substantially along the diagonal line. Here, the diagonal line is a diagonal line drawn from the right-front end portion to the left-rear end portion of the rigid member main body 60. Further, a range from the second rib portion 74 on the left side to the third rib portion 76 on the right side through the intermediate portion in the right-left direction of the first rib portion 72 is substantially along the diagonal line drawn from the left-front end portion to the right-rear end portion of the rigid member main body 60. With this configuration, it is possible to easily secure the rigidity of the rigid member 58 as compared with the configuration in which the above range in the rib 62 is not along the diagonal line.

In the present embodiment, the first opening 68 and the second opening 70 provided in the rigid member main body 60 can also function as clearance portions for avoiding interference with a member (for example, a part of the motor 14 or a connector of the wiring) supported by the suspension member 12. With this configuration, it is possible to avoid the interference between the member supported by the suspension member 12 and the rigid member 58.

In the present embodiment, the example in which the above range in the rib 62 is along the diagonal line has been described, but the present disclosure is not limited thereto. Whether the above range in the rib 62 is set along the diagonal line may be appropriately set in consideration of the rigidity and the like required for the rigid member 58.

In the present embodiment, an example has been described in which the first rib portion 72 constituting a part of the rib 62 is provided along the rear edge of the first opening 68 and the front edge of the second opening 70, but the present disclosure is not limited thereto. Whether the rib 62 is provided along the edge of the first opening 68 and the edge of the second opening 70 may be appropriately set in consideration of the degree of influence on the rigidity of the rigid member main body 60 due to providing the first opening 68 and the second opening 70.

Although an embodiment of the present disclosure has been described above, the present disclosure is not limited to the above, and can be variously modified and implemented within the scope of the spirit of the present disclosure.

What is claimed is:

1. A suspension member structure comprising:
a suspension member; and
a rigid member that is plate-shaped and that is attached to the suspension member to reinforce the suspension member, wherein:
a rib that suppresses deformation in a thickness direction of the rigid member is provided in the rigid member; and
an opening is provided in the rigid member in a portion that is different from a portion in which the rib is provided, the opening penetrating the rigid member.

2. The suspension member structure according to claim 1, wherein the rib is provided along an edge of the opening.

3. The suspension member structure according to claim 1, wherein:
the rigid member is rectangular-shaped when viewed in the thickness direction; and
the rib is provided along a diagonal line of the rigid member.

4. The suspension member structure according to claim 1, wherein the opening is a clearance portion for avoiding interference with a member supported by the suspension member.
